(19) United States
(12) Patent Application Publication
(10) Pub. No.: US 2026/0298712 A1
(43) Pub. Date: Oct. 1, 2026

(54) FIRE CLASSIFICATION BASED FLAME DETECTION

(71) Applicant: Spectronix Ltd., Sderot (IL)

(72) Inventors: Emil COHEN, Netivot (IL); Dimitriy GRIGOROVITCH, Be'er Sheva (IL); Tsviel BOUHBUT, Be’er Sheva (IL); Eyal BEN ARZI, Ashqelon (IL)

(21) Appl. No.: 19/089,262

(22) Filed: Mar. 25, 2025

(51) Int. Cl. G01J 3/443; G01J 3/02; G01J 3/10; G01J 3/51; G01N 21/71; G08B 17/12; G01J 3/28

(52) U.S. Cl. CPC G01J 3/443; G01J 3/0294; G01J 3/108; G01J 3/51; G01N 21/71; G08B 17/12; G01J 2003/283; G01N 2201/13

(57) ABSTRACT

A flame detection system is provided. The flame detection system includes a plurality of sensing channels, each sensing channel being configured to detect specific emission wavelengths of combustion of a particular combustible material among a plurality of combustible materials. At least one reference channel is also provided. A processor is operably coupled to the plurality of sensing channels and the at least one reference channel. The processor is configured to obtain signals from the plurality of sensing channels and the at least one reference channel and detect flame based on the analysis. The processor is further configured to identify one or more materials combusting in the detected flame based on the analysis of the signals from the plurality of sensing channels and at least one reference channel. A method of detecting and characterizing flame is also provided.

### BACKGROUND

The process control and monitoring industry supports a wide range of process industries. Some of the process industries may employ or process materials that are highly flammable or even explosive. Examples of such industries include chemical processing facilities as well as petroleum extraction and refining. In such environments, fires and explosions are a significant hazard. In these highly volatile environments, it is useful and sometimes required to use one or more optical detectors, such as optical flame detectors, which detect any flame in the process environment so that such flame can be quickly extinguished.

### SUMMARY

A flame detection system is provided. The flame detection system includes a plurality of sensing channels, each sensing channel being configured to detect specific emission wavelengths of combustion of a particular combustible material among a plurality of combustible materials. At least one reference channel is also provided. A processor is operably coupled to the plurality of sensing channels and the at least one reference channel. The processor is configured to obtain signals from the plurality of sensing channels and the at least one reference channel and detect flame based on the analysis. The processor is further configured to identify one or more materials combusting in the detected flame based on the analysis of the signals from the plurality of sensing channels and at least one reference channel. A method of detecting and characterizing flame is also provided.

### BRIEF DESCRIPTION OF THE DRAWINGS

FIG. 1 is a system block diagram of a multi-channel optical sensor with which embodiments described herein are particularly useful.

FIG. 2 is a chart illustrating a signal channel and a reference channel response for known flame detection.

FIG. 3 is a chart illustrating different emission spectra for different flames (e.g., hydrogen and hydrocarbon).

FIG. 4 is a system block diagram of an optical flame detection system in accordance with an embodiment of the present invention.

FIG. 5 is a flow diagram of a method of optically detecting and characterizing flame in accordance with an embodiment of the present invention.

### DETAILED DESCRIPTION OF ILLUSTRATIVE EMBODIMENTS

Embodiments described herein generally enhance the capabilities of conventional flame detectors by introducing a sophisticated multi-channel sensor system designed to detect and analyze multiple emission peaks simultaneously. Unlike traditional systems that generally respond to common combustion by-products like CO₂ and H₂O, this advanced system utilizes distinct sensor channels, each is specifically tuned to different emission signatures from various materials. The system includes additional reference channels to support the classical triple infrared (IR) detection principle. When emissions are detected, the system not only confirms the presence of a flame but also determines the type of material burning, based on the wavelength of the emission peaks detected.

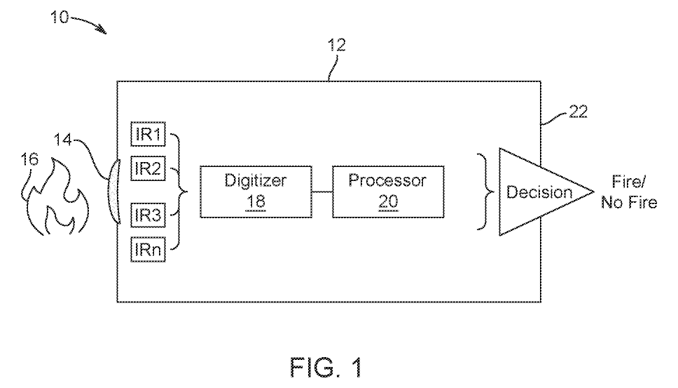

Before describing various embodiments, a brief introduction to multi-channel spectral flame detection is provided. FIG. 1 is a system block diagram of a multi-channel optical sensor with which embodiments described herein are particularly useful. Multi-channel optical sensor 10, when used in the context of optical flame detection, is a device designed to detect the presence of flames by analyzing emission across multiple spectral bands or channels. Using multiple channels provides a number of advantages. First, detection accuracy is enhanced since different materials combust with different spectral characteristics. A multi-channel sensor can detect various types of fires by analyzing different parts of the electromagnetic spectrum, including ultraviolet (UV), visible light, and infrared (IR) bands. Second, the rate of false alarms is reduced by comparing the intensity of emission across several channels, these sensors can differentiate between actual flames and other emission sources that might cause false alarms, such as sunlight, artificial lights, or reflections. Third, reliability is improved since multi-channel sensors can operate effectively in a variety of environmental conditions, reducing the risk of detection failures due to factors like dust, moisture, or other atmospheric obscurants.

Sensor 10 includes a housing 12 having a lens 14 through which flames 16 are visible. Flames 16 emit a broad spectrum of infrared radiation. The sensor 10 includes a plurality of individual IR sensors IR1, IR2, IR3, …IRₙ, where each individual sensor is sensitive to a particular band or IR wavelength. Thus, each individual sensor is essentially tuned or otherwise focused to relevant flame emission wavelengths. Each or IR sensors IR1, IR2, IR3, … IRₙ is operably coupled to digitizer 18, which includes circuitry to convert an analog signal of an individual IR sensor to a digital representation thereof. Digitizer 18 is coupled to processor 20 and is configured to provide the digital representations related to the various IR sensors to processor 20.

Processor 20 is any suitable device that is able to execute programmatic steps or functions to provide various features of sensor 10. Examples of such devices include digital signal processors, microcontrollers, field programmable gate arrays, and application specific integrated circuits. In some examples, processor 20 is a microprocessor. Digitizer 18 provides digitized representations of the IR sensor signals to processor 20 for signal processing. Processor 20 processes the digitized signals from the IR sensors and analyzes the signals from each IR sensor. Processor 20 attempts to identify specific patterns associated with flame flicker and intensity. In order to analyze the flame flicker frequency, processor 20 generally transforms the signal from time domain to frequency (FFT). By comparing the output of multiple IR sensors, processor 20 can distinguish between a flame and other IR sources like sunlight, hot machinery, or artificial lighting. The feature is achieved by analyzing the intensity and frequency response of each channel. Real flame is characterized as low frequency signals with response of 1-5Hz, and by high intensity signal at signal channels together with low intensity at reference channels. The correlation (frequency response) of the channels is expected to be high, but not full correlation, which would indicate an artificial signal. This multi-spectral analysis reduces false alarms. Processor 20 executes methods to apply such analysis to calculate the integral of the signals which will correspond to flame intensity, calculate ratios between the channels for understanding the signal channels are higher than the reference channels. The final step is to compare the frequency behavior between the different channels to measure the correlation between them.

When processor 20 confirms the presence of a flame, it generates an output 22, such as triggering an alarm and/or other suitable actions. Sensor 10 can also initiate automatic safety measures, such as shutting down equipment and/or activating fire suppression systems.

A known type of flame detection is referred to as classical Triple infra-red (IR3) detection. This type of detection is based on the system shown above and uses one signal channel and two reference channels and calculates ratios between the reference and signal channels and correlations between them. Triple IR flame detection is a method of detecting flames by using three infrared (IR) sensors to identify specific wavelengths of infrared radiation emitted during combustion. This technology is used in a variety of industrial applications, such as manufacturing plants and petrochemical facilities, where it can help to reduce the risk of false alarms.

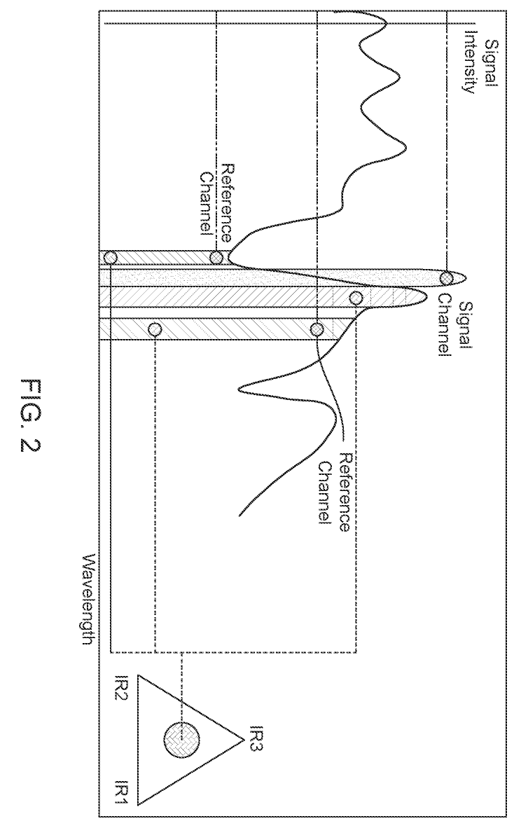

FIG. 2 is a chart illustrating a signal channel and a reference channel response for known flame detection. In FIG. 2, the spectral behavior of flame detected by the classical Triple IR system can be seen. The interface between the sensors is done by processor 20, which obtains the data from each sensor and analyzes it. The hardware selected for processor 20 should be configured to process sufficient channels with sufficient speed. There are memory requirements and speed requirements. The memory needed is equal to 3 bytes for each sample, multiplied by 1000 samples per second and multiplied by 120 which is the size of the typical buffer. Thus, a total of 360KB memory per channel is required. To calculate the number of CPU cycles, we will use five cycles per one multiplication, 1000 multiplications per second, which means 5000 CPU cycles per channel. The number shown above shows the computer power needed to process six channels, which is less than typical computing power provided by the average commercially-available embedded microcontroller unit (MCU).

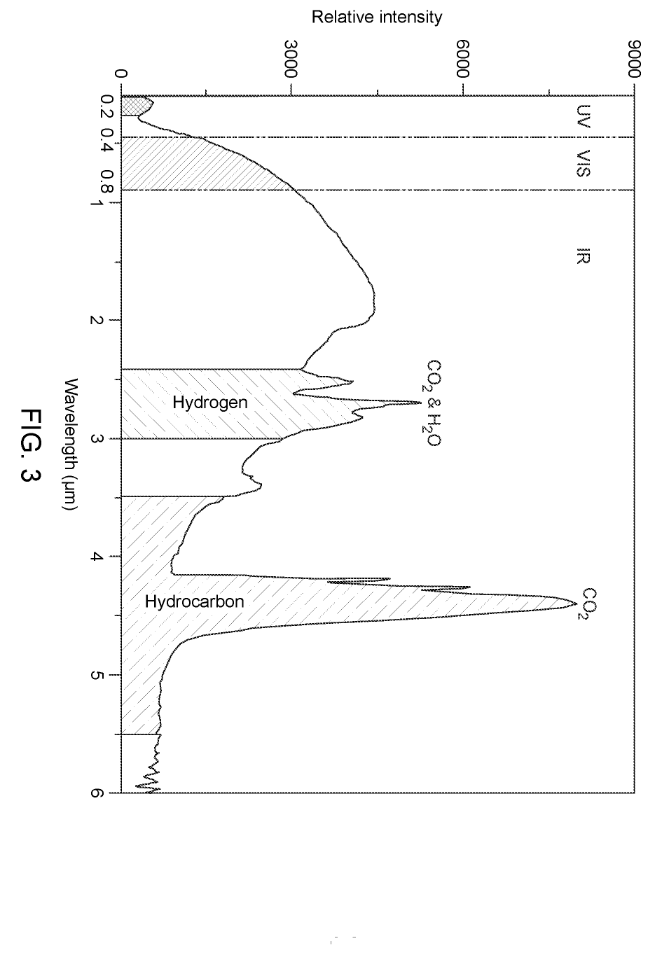

Conventional flame detection systems are primarily designed to detect the presence of a flame based on the emission of certain by-products such as CO₂ and H₂O (See FIG. 3). These systems typically employ detection techniques and methods that activate based on predetermined ratios and correlations between different sensor channels. However, these traditional methods fall short of accurately identifying the type of material burning, as they do not differentiate between various chemical signatures of flames. This limitation can lead to suboptimal responses to fires, as the specific type of fire may require a tailored approach for effective suppression. Furthermore, existing systems may struggle with false alarms or inaccurate detection in complex scenarios where multiple materials are involved.

Known flame detectors are typically designed to detect either a hydrocarbon flame with a signal peak at 4.5um or a hydrogen flame with a signal emission peak at 2.7um. Those detectors are not able to compare the emission at 2.7um and 4.5um to more precisely tell the source of the flame—whether it is a hydrocarbon-based or hydrogen-based flame. This is needed because at some facilities, the process combines both flame sources, and in some cases, a "friendly" fire, resulting from burning process leftovers, may trigger unwanted alarm.

Embodiments disclosed herein generally provide a flame detection system and method that incorporates multiple sensor channels, each dedicated to detecting specific emission wavelengths associated with different burning materials.

For example as mentioned above, the hydrogen flame has an emission peak at 2.7um, and hydrocarbon flame at 4.5um, as shown in FIG. 3. Embodiments provided herein generally employ two or more signal channels where each signal channel is tuned or otherwise responsive to a different wavelength. The various tuned wavelengths represent emission spectra from burning of different materials. A number of reference channels are also used to ensure the signal is created by genuine flame. This arrangement allows the detection of two or more flames simultaneously, along with the ability to generate an indication of which material is burning. While embodiments will generally be described with respect to a pair of different signal channels tuned to 2.7 um and 4.5 um, respectively, this is provided to facilitate an understanding of embodiments of the invention. Certainly, embodiments can include additional signal channels tuned to emission peaks of other materials as well. The number of signal channels and emission spectra is only limited by economic factors and available space for such components within the flame detector. Accordingly, embodiments include a vast number of different signal channels tuned for a similarly vast number of different materials.

This multi-faceted approach not only enhances the sensitivity of the detection process by allowing the better ability to distinguish between real flame and false alarm sources- by having the ability to accurately tune the optical filter to the expected wavelength, according to desired material detection but also improves specificity by incorporating reference channels that uphold the classical triple IR detection principles. In some examples, two or more IR3 systems are created where each IR3 system is specifically tuned to a different material burning.

The system employs processing techniques and methods to analyze the ratios between the signals received from each channel. This approach compares the observed emission ratios to a database of known flame signatures to identify the type of flame (i.e., material combusting) present. A classic IR3 has one signal channel and 2 reference channels. In contrast, embodiments disclosed herein employ two or more signal channels (each tuned to different characteristic emission spectra of a particular material) and multiple reference channels. This allows the detected signal to be analyzed using spectrometry principles. Based on such analysis, embodiments described herein accurately detect the material of combustion by recognizing its spectral signature and not just by the ratio between the signal and reference channel.

When a match is detected, the system classifies the flame type and facilitates an informed response, enabling the deployment of appropriate fire suppression methods tailored to the specific characteristics of the fire. This targeted approach significantly increases the efficacy of fire response measures and reduces the likelihood of damage caused by using incorrect suppression techniques. One advantage of embodiments described herein is that training is not required. Instead, in some examples, the system can be pre-calibrated using different flame sources during manufacture. The output of the system can take any suitable form. The output may be in the form of dry contact relays, wherein each relay is indicative of a different fire type. In another example, an analog output is provided with different 0-20mA levels for each fire type. Of course, the digital communication which is part from each flame detector can indicate the detected fire type.

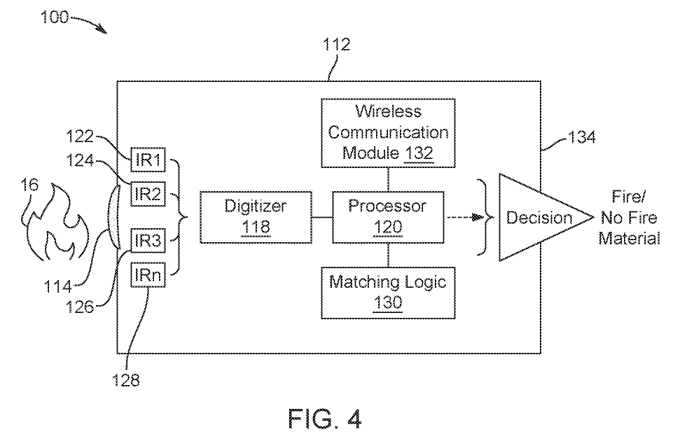

FIG. 4 is a system block diagram of an optical flame detection system in accordance with an embodiment of the present invention. System 100 bears some similarities to system 10, and like components are numbered similarly. Flame detector 100 includes a housing 112 having a window or lens 114 that allows illumination/radiation from flame 16 to pass through and reach IR sensors 122, 124, 126, and 128. While FIG. 4 shows four such IR sensors, it is expressly contemplated that any suitable number (n) of IR sensors may be used, as IR sensor 128 is labelled IRₙ. Additionally, while a single window/lens 114 is shown, window/lens 114 may be in the form of a number of individual windows/lenses 114, with each individual window/lens proximate each respective IR sensor. Further, in such embodiments, each window/lens 114 may include an optical filter such that only illumination of a particular wavelength range (e.g., a range that corresponds to emission spectra of a material of interest such as hydrogen). In other example, individual filters may be positioned within housing 112 between window/lens 114 and each individual IR sensor 122, 124, 126, and 128. Regardless, each of the IR sensors 122, 124, 126, and 128 is sensitive to different emission spectra. In one example, IR sensor 122 may be sensitive to illumination having a wavelength of 2.7um (CO₂ and H₂O) while IR sensor 124 is sensitive to illumination having a wavelength of 4.5um (hydrogen).

Each IR sensor 122, 124, 126, and 128 is operably coupled to digitizer 118, which includes circuitry to convert an analog signal of an individual IR sensor to a digital representation thereof. Such circuitry may include suitable amplification circuitry as well as an analog-to-digital converter. Digitizer 118 is coupled to processor 120 and is configured to provide the digital representations related to the various IR sensors 122, 124, 126, and 128 to processor 120.

Processor 120, like processor 20, is any suitable device that is able to execute programmatic steps or functions to provide various features of sensor 100. Examples of such devices include digital signal processors, microcontrollers, field programmable gate arrays, and application specific integrated circuits. In some examples, processor 120 is a microprocessor. Digitizer 118 provides digitized representations of the signals from IR sensors 122, 124, 126, and 128 to processor 120 for signal processing. Processor 120 can process the digitized signals in the same way as processor 20, (described above with respect to FIG. 1) to detect flame in accordance with any suitable techniques. However, processor 120 is also coupled to or includes matching logic 130. Matching logic 130 includes information that relates various possible materials to emission spectra. In one example, matching logic 130 compares the observed emission ratios to a database (either stored locally or remotely via optional wireless communication module 132) of known flame signatures, patterns, or reference data to identify the material or materials combusting. Wireless communication module 132 allows processor 120 to communicate with a remote device that may host the emission ratio database or other suitable flame signature information. Such communication can take any suitable form but is preferably wireless communication. Examples of wireless communication include, without limitation: the WirelessHART process communication protocol (IEC62591); a cellular communication protocol such as GPRS, UMTS, CDMA2000, LTE, LTE-M, NB-IOT, WiMax, 5G NR.; a WiFi standard, such as IEEE 802.11 b/g/n/a/ac/ax/be; and LoRaWAN protocol (ITU-T Y.4480).

The matching process can include comparing the degree of matching to a pre-determined match threshold such that a match that is above the pre-determined threshold will be identified as a match. The pre-determined threshold may be set during manufacture and/or may be user-selectable. In another example, matching logic may simply report the degree of match (i.e., 85%). Additionally, it is also contemplated that matching logic 130 may identify more than one type of combustible material. In still other embodiments, matching logic 130 may identify, based on observed emission, other types of materials (e.g., gases that may be harmful to first responders) and provide an indication of such detection as well.

Sensor 100 provides, as an output 134, not only an indication of the presence of flame, but also an indication of the material or materials that are combusting. This significantly improves the efficacy of remedial efforts as well as helps protect the safety of those involved.

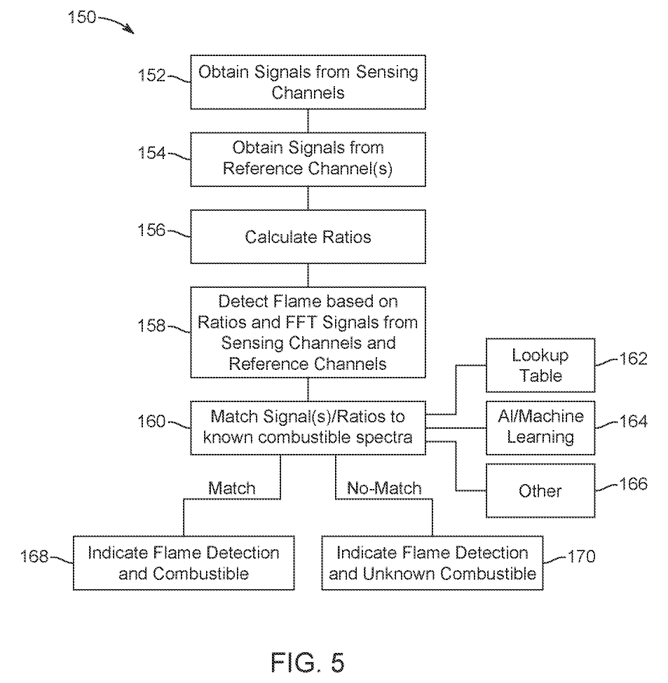

FIG. 5 is a flow diagram of a method of optically detecting and characterizing flame in accordance with an embodiment of the present invention. Method 150 begins at block 152 where a processor, such as processor 120, obtains signals from IR sensing channels, where each channel is sensitive to a different IR wavelength. Next, at block 154, the processor obtains one or more reference channel signals. At block 156, various ratios of signal channel to reference channel(s) are computed. At block 158, the processor performs an FFT analysis on the signal channels as well as the reference channel(s) and analyzes the computed ratios to determine whether a flame exists. This analysis can be the same as or similar to current triple IR processing. In the event that a flame is detected, control passes to block 160 where the processor matches the signals and computed ratios to known combustible spectral signatures, patterns, or fingerprints. This matching process may include the use of a lookup table 162, AI/machine learning 164, and/or any other suitable pattern matching techniques 166. If a match is found, control passes to block 168 where a flame indication is provided as well as an indication of the material or materials that are combusting.

Embodiments described herein are believed to be useful to a number of industries and applications. For example, in environmental monitoring, embodiments could be used to monitor and analyze emissions from industrial processes, helping to identify and classify different types of pollutants released into the atmosphere. This could be useful for regulatory compliance and in efforts to reduce a facility's environmental impact.

Another example application is safety systems in transportation. Utilizing embodiments described herein in vehicles, including ships and aircraft, could enhance safety by providing early detection and classification of fires, thereby allowing for quicker and more appropriate responses to incidents like engine fires or cargo area fires.

Yet another example application is in building management. Integrating fire classification systems into smart building management systems could enhance fire safety protocols. Buildings could automatically activate specific fire suppression systems tailored to the type of fire detected, such as electrical fires versus kitchen fires, improving both safety and damage control.

Yet another example application is hazardous material management. In facilities that handle various flammable and hazardous materials, such systems could provide important data about the type of fire and its source, facilitating a faster and more specific response, which is important for ensuring the safety of the facility and minimizing environmental damage.

Yet another example application is quality control in manufacturing. In industries where heat processes are used, such as in metalworking or glass manufacturing, the ability to monitor and classify types of heat and flame can be used for quality control, ensuring that materials are processed in the ideal flame conditions for optimal product quality.

Yet another example application is energy production safety. In energy production sectors, especially in plants that use combustion processes, such technology could monitor and classify flames continuously to ensure that combustion is occurring correctly and safely, preventing accidents and improving efficiency.

Although the present invention has been described with reference to preferred embodiments, workers skilled in the art will recognize that changes may be made in form and detail without departing from the spirit and scope of the invention.

What is claimed is:

1. A flame detection system comprising:
a plurality of sensing channels, each sensing channel being configured to detect specific emission wavelengths of combustion a particular combustible material among a plurality of combustible materials;
at least one reference channel; and
a processor operably coupled to the plurality of sensing channels and the at least one reference channel, the processor being configured to obtain signals from the plurality of sensing channels and the at least one reference channel and detect flame based on the analysis, the processor being further configured to identify one or more materials combusting in the detected flame based on the analysis of the signals from the plurality of sensing channels and at least one reference channel.

2. The flame detection system of claim 1, wherein each sensing channel is individually tuned to a distinct emission signature specific to particular combustible material.

3. The flame detection system of claim 2, wherein each sensing channel is individually tuned using an optical filter.

4. The flame detection system of claim 2, wherein one sensing channel of the plurality of sensing channels is tuned to around 2.7 um.

5. The flame detection system of claim 4, wherein another sensing channel of the plurality of sensing channels is tuned to around 4.5 um.

6. The flame detection system of claim 1, wherein the processor is configured to analyze ratios between signals received from each of the sensing channels to determine the type of material burning based on the wavelength of the emission peaks detected.

7. The flame detection system of claim 6, wherein the processor is configured to compare observed emission ratios against a pre-established database of known flame signatures to identify the one or more materials combusting in the detected flame.

8. The flame detection system of claim 7, wherein the pre-established database is contained within matching logic of the flame detector.

9. The flame detection system of claim 8, wherein the matching logic is coupled to the processor.

10. The flame detection system of claim 8, wherein the matching logic is part of the processor.

11. The flame detection system of claim 7, wherein the pre-established database of known flame signatures is remote from the flame detection system and the processor is configured to communicate with a remote device to access the pre-established database of known flame signatures.

12. The flame detection system of claim 1, wherein the processor is configured to provide an output indicative of flame detection as well as being indicative of the one or more materials combusting.

13. The flame detection system of claim 12, wherein the output indicative of one or more materials combusting is provided in the form of a relay closure.

14. The flame detection system of claim 12, wherein the output indicative of one or more materials combusting is provided using a 4-20 mA current loop.

15. The flame detection system of claim 1, wherein the indication of one or more materials combusting facilitates targeted fire suppression response.

16. A method of detecting and characterizing flame, the method comprising:
obtaining signals from a plurality of sensing channels, each sensing channel being configured to detect specific emission wavelengths of combustion a particular combustible material among a plurality of combustible materials;
obtaining a signal from a reference channel;
calculating ratios of each signal to the reference signal;
detecting flame based on the calculated ratios and a frequency analysis of the signals from the plurality of sensing channels;
matching the ratios to known flame information for combustible materials to identify one or more materials combusting in the flame; and
providing an output indicative of flame detection as well as material combusting in the detected flame.

17. The method of claim 16, wherein matching the ratios to known flame information includes employing a lookup table having known flame ratio information.

18. The method of claim 16, wherein matching the ratios to known flame information includes employing machine-learning processing.

19. The method of claim 16, and further comprising providing an indication that the flame is of an unknown combustible.
